(19) United States
(12) Patent Application Publication
(10) Pub. No.: US 2024/0136589 A1
(43) Pub. Date: Apr. 25, 2024

(54) LITHIUM AIR BATTERY WITH IMPROVED CYCLABILITY

(71) Applicant: KOREA ADVANCED INSTITUTE OF SCIENCE AND TECHNOLOGY, Daejeon (KR)

(72) Inventors: Hye Ryung Byon, Daejeon (KR); Jin-Hyuk Kang, Daejeon (KR); Jiwon Park, Daejeon (KR); Moony Na, Daejeon (KR)

(21) Appl. No.: 18/496,640

(22) Filed: Oct. 26, 2023

(30) Foreign Application Priority Data
Oct. 23, 2022 (KR) 10-2022-0137504

(51) Int. Cl. H01M 10/0569; H01M 4/38; H01M 10/0568; H01M 12/08

(52) U.S. Cl. CPC H01M 10/0569; H01M 4/382; H01M 10/0568; H01M 12/08; H01M 2004/027

(57) ABSTRACT

The present disclosure relates to a lithium air battery including: an anode including lithium; a cathode located so as to face the anode and using oxygen as a cathode active material; an electrolyte solution located between the anode and the cathode and containing a solvent and a lithium salt; and carbon dioxide, wherein the solvent is a heteroaliphatic solvent having a dielectric constant of 30 or more and containing a nitrogen atom or a sulfur atom. The present disclosure may provide a lithium air battery that reduces a discharge product that deteriorates performance of the lithium air battery and exhibits improved cyclability at a low temperature.

### CROSS-REFERENCE TO RELATED APPLICATION

This application claims priority under 35 U.S.C. § 119 to Korean Patent Application No. 10-2022-0137504, filed on Oct. 24, 2022, in the Korean Intellectual Property Office, the disclosure of which is incorporated herein by reference in its entirety.

### TECHNICAL FIELD

The following disclosure relates to a lithium air battery. The following disclosure may provide a lithium air battery that reduces a discharge product that deteriorates performance of the lithium air battery and exhibits improved cyclability at a low temperature.

### BACKGROUND

Lithium-ion secondary batteries have recently been in the spotlight, but due to a low energy density, many studies have been conducted on lithium air batteries as a type of battery with a higher energy density. The capacity of the lithium air battery is currently expected to have an energy density three to five times higher than that of the lithium-ion battery at a material level. However, the lithium air battery has poor cyclability for two reasons. This is because, first, a superoxide radical (O₂^{⋅-}), which is an intermediate of lithium peroxide (Li₂O₂), deteriorates a carbon-based electrode and an electrolyte solution, and second, lithium carbonate (Li₂CO₃), which is a by-product, has a high charge potential of 4.5 V (vs. Li/Li⁺) or less, causing unwanted electrochemical oxidation. Although a redox mediator and an accelerator appear to suppress such side reactions during the initial cycle, the cyclability is not significantly improved.

Meanwhile, a peroxodicarbonate (C₂O₆²⁻) dianion may be formed as an intermediate of Li₂CO₃ in an electrolyte solution containing a non-aqueous solvent such as dimethyl sulfoxide (DMSO) or tetraglyme. Such a soluble material is less reactive than O₂^{⋅-} and is oxidized at a low charge potential (3.75 V or less). Therefore, C₂O₆²⁻ is a preferred discharge product over O₂^{⋅-}, Li₂O₂, and Li₂CO₃. Accordingly, CO₂ gas is mixed with O₂ to form the intermediate in the electrolyte, such that more excellent cyclability is exhibited than in a Li—O₂ battery alone. However, as C₂O₆²⁻ is easily converted into Li₂CO₃ at room temperature, deposition of Li₂CO₃ increases rapidly. A second charge plateau (4.5 V or less) is related to oxidation of Li₂CO₃. This plateau appears clearly after the first cycle, and the first plateau associated with C₂O₆²⁻ quickly disappears. This is due to incomplete decomposition of Li₂CO₃ during charging. As a result, the capacity of the Li—O₂/CO₂ battery is rapidly reduced due to accumulation of Li₂CO₃, and the cyclability is poor.

When a solvent having a low conductivity is used as the electrolyte solution of the battery, the first charge plateau may be extended, but the low ionic conductivity increases voltage polarization and ultimately results in poor cyclability of the lithium air battery.

### SUMMARY

An embodiment of the present disclosure is directed to providing a lithium air battery that reduces a discharge product that deteriorates performance of the lithium air battery and exhibits improved cyclability at a low temperature.

In one general aspect, a lithium air battery includes: an anode including lithium; a cathode located so as to face the anode and using oxygen as a cathode active material; an electrolyte solution located between the anode and the cathode and containing a solvent and a lithium salt; and carbon dioxide, wherein the solvent is a heteroaliphatic solvent having a dielectric constant of 30 or more and containing a nitrogen atom or a sulfur atom. The solvent may have 2 to 8 carbon atoms.

The solvent may be at least one selected from the group consisting of dimethylacetamide (DMAc), dimethyl sulfoxide (DMSO), dimethylformamide (DMF), acetonitrile, and nitromethane.

The solvent may be an amide-based compound.

The lithium air battery may be operated at a temperature that is equal to or higher than a melting point of the solvent and is 5° C. or lower.

The lithium air battery may be operated at −20 to 0° C.

The carbon dioxide may be supplied to one side of the cathode as a mixed gas mixed with oxygen.

A volume ratio of the oxygen to the carbon dioxide in the mixed gas may be 5:5 to 9:1.

The carbon dioxide may be dissolved in the electrolyte solution.

A Gutmann donor number (DN) of the solvent may be 25 to 30.

The lithium air battery may further include a separator located between the cathode and the anode.

The cathode may include a carbon body.

The lithium salt may include at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄F₁₀NO₄S₂ (LiBETI), LiPF₆, LiBF₄, LiSbF₆, LiAsF₆, LiC₄F₉SO₃, LiClO₄, LiAlO₂, LiAlCl₄, LiCl, LiI, LiBr, and LiB(C₂O₄)₂.

The lithium salt may include LiNO₃.

In another general aspect, an electrolyte composition for a lithium air battery includes: a lithium salt; a heteroaliphatic solvent having a dielectric constant of 30 or more and containing a nitrogen atom or a sulfur atom; and dissolved carbon dioxide.

The solvent may have 2 to 8 carbon atoms.

The solvent may be at least one selected from the group consisting of dimethylacetamide (DMAc), dimethyl sulfoxide (DMSO), dimethylformamide (DMF), acetonitrile, and nitromethane.

The solvent may be an amide-based compound.

The solvent may be dimethylacetamide (DMAc).

The lithium salt may include at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄F₁₀NO₄S₂ (LiBETI), LiPF₆, LiBF₄, LiSbF₆, LiAsF₆, LiC₄F₉SO₃, LiClO₄, LiAlO₂, LiAlCl₄, LiCl, LiI, LiBr, and LiB(C₂O₄)₂.

The lithium salt may include LiNO₃.

Other features and aspects will be apparent from the following detailed description, the drawings, and the claims.

### BRIEF DESCRIPTION OF THE DRAWINGS

FIGS. 1A to 1D are diagrams showing gas analysis and product properties of K₂C₂O₆ powder with a Li—O₂/CO₂ battery (volume ratio of O₂:CO₂=9:1) and 0.5 M LiTFSI/tetraglyme.

FIG. 2A is a digital photograph of light orange K₂C₂O₆ powder, FIG. 2B is a diagram showing a Raman spectrum of K₂C₂O₆, and FIG. 2C is a diagram showing an FTIR spectrum of K₂C₂O₆.

FIGS. 3A to 3D are diagrams showing temperature-dependent constant current profiles of a Li—O₂/CO₂ battery including 0.5 M LiTFSI/tetraglyme at a current density of 50 mA·g_{c}⁻¹ and a capacity of 500 mAh·g_{c}⁻¹.

FIGS. 4A and 4B are diagrams showing temperature-dependent constant current profiles of a Li—O₂/CO₂ battery including 0.5 M LiNO₃/DMAc at a current density of 50 mA·g_{c}⁻¹ and a capacity of 500 mAh·g_{c}⁻¹.

FIGS. 5A to 5F are diagrams showing Raman spectra for discharge products and DFT calculations for anhydride-linked C₂O₆²⁻ and peroxo-linked C₂O₆²⁻.

FIGS. 6A to 6C are diagrams of cycle tests of a Li—O₂/CO₂ battery including 0.5 LiNO₃/DMAc at −10° C. and a current density of 50 mA·g_{c}⁻¹.

FIGS. 7A, 7C, and 7E are SEM images of the initial state of a CNT electrode, and FIGS. 7B, 7D, and 7F are SEM images of the CNT electrode after 70 cycles.

### DETAILED DESCRIPTION OF EMBODIMENTS

Technical terms and scientific terms used in the present specification have the general meaning understood by those skilled in the art to which the present disclosure pertains unless otherwise defined, and a description for the known function and configuration unnecessarily obscuring the gist of the present disclosure will be omitted in the following description.

In addition, unless the context clearly indicates otherwise, the singular forms used in the present specification may be intended to include the plural forms.

In addition, a numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the specification of the present disclosure, values out of the numerical range that may occur due to experimental errors or rounded values also fall within the defined numerical range.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or steps, all of which are not further recited herein.

Hereinafter, a lithium air battery of the present disclosure will be described in detail.

The present disclosure provides a lithium air battery including: an anode including lithium; a cathode located so as to face the anode and using oxygen as a cathode active material; an electrolyte solution located between the anode and the cathode and containing a solvent and a lithium salt; and carbon dioxide, wherein the solvent is a heteroaliphatic solvent having a dielectric constant of 30 or more and containing a nitrogen atom or a sulfur atom.

In an exemplary embodiment, the solvent may have a dielectric constant of 30 or more or 35 or more. In addition, the solvent may have a dielectric constant of 70 or less, 60 or less, 50 or less, 45 or less, or 40 or less. The dielectric constant of the solvent may be 30 to 50, specifically, 30 to 40, and more specifically, 35 to 40. When a solvent having a high dielectric constant is used as an electrolyte solution in a battery, cyclability may be improved. This is because such a solvent exhibits a high ionic conductivity at a low temperature and a first charge plateau proportion may increase during cycling.

In an exemplary embodiment, the solvent may contain a nitrogen atom or a sulfur atom, but is not limited thereto. Specifically, the solvent may contain a nitrogen atom.

In an exemplary embodiment, the solvent may have 1 to 8 carbon atoms, specifically, 2 to 8 carbon atoms, more specifically, 2 to 7 carbon atoms, more specifically, 3 to 6 carbon atoms, and still more specifically, 4 or 5 carbon atoms.

In an exemplary embodiment, the solvent may be at least one selected from the group consisting of dimethylacetamide (DMAc), dimethyl sulfoxide (DMSO), dimethylformamide (DMF), acetonitrile, and nitromethane, but is not limited thereto.

In an exemplary embodiment, the solvent may be an amide-based compound, and specifically, the solvent may be dimethylacetamide (DMAc). When a dimethylacetamide (DMAc) solvent is used, the cyclability may be improved. This is because such a solvent exhibits a high ionic conductivity at a low temperature and the first charge plateau proportion may increase during cycling.

In an exemplary embodiment, it is preferable that the lithium air battery is operated at a low temperature region. According to an exemplary embodiment, the lithium air battery may be operated at a temperature that is equal to or higher than a melting point of the solvent and is 5° C. or lower. Specifically, the lithium air battery may be operated at a temperature that is equal to or higher than the melting point of the solvent and is 0° C. or lower, and more specifically, the lithium air battery may be operated at a temperature that is equal to or higher than the melting point of the solvent and is −5° C. or lower. As the lithium air battery is operated at the low temperature range as described above, C₂O₆²⁻, which is a discharge product, may be stabilized, and therefore, an effect of extending the first charge plateau may be achieved, which is preferable.

In an exemplary embodiment, the lithium air battery may be operated at 5° C. or lower, 0° C. or lower, −5° C. or lower, −10° C. or lower, −15° C. or lower, -20° C. or lower, −25° C. or lower, or −30° C. or lower, and the lithium air battery may be operated, without limitation, at 0° C. or higher, −5° C. or higher, −10° C. or higher, −15° C. or higher, −20° C. or higher, −25° C. or higher, −30° C. or higher, −35° C. or higher, or −40° C. or higher.

In an exemplary embodiment, the lithium air battery may be operated at −40° C. to 5° C., specifically, −30° C. to 5° C., more specifically, −20° C. to 5° C., more specifically, −20° C. to 0° C., more specifically, −15° C. to 0° C., and still more specifically, −10° C. to 0° C.

In an exemplary embodiment, the carbon dioxide included in the lithium air battery may be supplied to one side of the cathode as a mixed gas mixed with oxygen. As a more specific example, the mixed gas may be supplied to one side of the cathode in the form of natural convection or forced convection, but is not limited thereto. As the mixed gas is supplied to one side of the cathode, oxygen is used as an active material in the cathode, and carbon dioxide is dissolved in the solvent, such that oxygen comes into contact with carbon dioxide, and C₂O₆²⁻, which is a discharge product, may be produced during discharging.

In an exemplary embodiment, a volume ratio of the oxygen to the carbon dioxide in the mixed gas may be 5:5 to 9.9:0.1, 6:4 to 9.9:0.1, 5:5 to 9.5:0.5, 6.5:3.5 to 9.5:0.5, 5:5 to 9:1, or 7:3 to 9:1.

In another exemplary embodiment, the carbon dioxide may be dissolved in the electrolyte solution. As the carbon dioxide is dissolved in the solvent contained in the electrolyte solution at a high concentration, C₂O₆²⁻, which is a discharge product as described above, may be produced in the electrolyte solution. Accordingly, the lithium air battery may be operated even when only oxygen or air is supplied to the one side of the cathode. However, since the carbon dioxide dissolved in the solvent is lost, a modified example in which a mixed gas containing carbon dioxide is supplementally supplied to one side of the cathode is also included in the present disclosure.

In an exemplary embodiment, a Gutmann donor number (DN) of the solvent may be 22 or more, 23 or more, 24 or more, 25 or more, 26 or more, or 27 or more. In addition, the Gutmann donor number (DN) of the solvent may be 35 or less, 34 or less, 33 or less, 32 or less, 31 or less, 30 or less, 29 or less, or 28 or less. In an exemplary embodiment, the Gutmann donor number (DN) of the solvent may be 22 to 35, specifically, 25 to 30, and more specifically, 26 to 28. When a solvent having a high Gutmann donor number is used as the electrolyte solution of the battery, a high ionic conductivity may be exhibited at a low temperature, and thus, the cyclability of the battery may be improved.

In an exemplary embodiment, the lithium air battery may further include a separator located between the cathode and the anode. The separator may include at least one selected from the group consisting of a polyolefin-based resin such as polyethylene or polypropylene; a fluorine-based resin such as polytetrafluoroethylene or polyvinylidene fluoride; a polyamide-based resin; and a polyimide-based resin such as polyamideimide or polyimide, but is not limited thereto. In addition, the separator may include inorganic fiber or inorganic powder such as glass fiber, mica, alumina, or silica without limitation.

In an exemplary embodiment, the cathode may include a carbon body. The carbon body may include at least one selected from the group consisting of fullerene, graphite, graphene, carbon black, Ketjenblack, a carbon fiber, and a carbon nanotube, but is not limited thereto. Specifically, the carbon body may be a carbon nanotube.

In an exemplary embodiment, the lithium salt may include at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄F₁₀NO₄S₂ (LiBETI), LiPF₆, LiBF₄, LiSbF₆, LiAsF₆, LiC₄F₉SO₃, LiClO₄, LiAlO₂, LiAlCl₄, LiCl, LiI, LiBr, and LiB(C₂O₄)₂, but is not limited thereto. Preferably, the lithium salt may include LiNO₃ or LiC₂F₆NO₄S₂(LiTFSI). More preferably, the lithium salt may include LiNO₃. As LiNO₃ is included as a lithium salt, the anode including lithium is stabilized and other side reactions are suppressed, which may be preferable.

In addition, the present disclosure provides an electrolyte composition for a lithium air battery, the electrolyte composition including: a lithium salt; a heteroaliphatic solvent having a dielectric constant of 30 or more and containing a nitrogen atom or a sulfur atom; and dissolved carbon dioxide.

In an exemplary embodiment, the solvent may have a dielectric constant of 30 or more or 35 or more. In addition, the solvent may have a dielectric constant of 70 or less, 60 or less, 50 or less, 45 or less, or 40 or less. The dielectric constant of the solvent may be 30 to 50, specifically, 30 to 40, and more specifically, 35 to 40. When a solvent having a high dielectric constant is used as an electrolyte solution in a battery, cyclability of the battery may be improved. This is because such a solvent exhibits a high ionic conductivity at a low temperature and a first charge plateau proportion may increase during cycling.

In an exemplary embodiment, the solvent may contain a nitrogen atom or a sulfur atom, but is not limited thereto. Specifically, the solvent may contain a nitrogen atom.

In an exemplary embodiment, the solvent may have 1 to 8 carbon atoms, specifically, 2 to 8 carbon atoms, more specifically, 2 to 7 carbon atoms, more specifically, 3 to 6 carbon atoms, and still more specifically, 4 or 5 carbon atoms.

In an exemplary embodiment, the solvent may be at least one selected from the group consisting of dimethylacetamide (DMAc), dimethyl sulfoxide (DMSO), dimethylformamide (DMF), acetonitrile, and nitromethane, but is not limited thereto.

In an exemplary embodiment, the solvent may be an amide-based compound, and specifically, the solvent may be dimethylacetamide (DMAc). When a dimethylacetamide (DMAc) solvent is used, the cyclability may be improved. This is because such a solvent exhibits a high ionic conductivity at a low temperature and the first charge plateau proportion may increase during cycling.

In an exemplary embodiment, the lithium salt may include at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄FiONO₄S₂ (LiBETI), LiPF₆, LiBF₄, LiSbF₆, LiAsF₆, LiC₄F₉SO₃, LiClO₄, LiAlO₂, LiAlCl₄, LiCl, LiI, LiBr, and LiB(C₂O₄)₂ , but is not limited thereto. Preferably, the lithium salt may include LiNO₃ or LiC₂F₆NO₄S₂ (LiTFSI). More preferably, the lithium salt may include LiNO₃. As LiNO₃ is included as a lithium salt, the anode including lithium is stabilized and other side reactions are suppressed, which may be preferable. Hereinafter, the present disclosure will be described in more detail with reference

to Examples and Comparative Examples. However, the following Examples and Comparative Examples are only examples for describing the present disclosure in more detail, and the present disclosure is not limited by the following Examples and Comparative Examples. In the present disclosure, unless otherwise specified, all temperatures refer to a unit of ° C., and the amount of composition used refers to a unit of wt %.

### PREPARATION EXAMPLE 1

### Preparation of Cathode, Anode, Electrolyte Solution, and Separator

As a solvent contained in an electrolyte, tetraethylene glycol dimethyl ether (tetraglyme, Sigma Aldrich), 1,2-dimethoxyethane (DME, Sigma Aldrich), dimethyl sulfoxide (DMSO, Sigma Aldrich), and N,N-dimethylacetamide (DMAc, Sigma Aldrich) were used, and lithium bistriflimide (LiTFSI, Sigma Aldrich) and lithium nitrate (LiNO₃, Sigma Aldrich) were used as lithium salts. A binder-free carbon nanotube (CNT) film was prepared as a working electrode. A metallic lithium foil (thickness: 50 μm, Honjo) and CNT (JENO 20A, >95% purity, JEIO) were used as an anode and a cathode, respectively. Polypropylene Celgard (Celgard 2500) and glass fiber (GF/C, Whatman) or GB100R glass fiber film (Adventec) were used together as separators.

### PREPARATION EXAMPLE 2

### Synthesis of K₂C₂O₆ Powder

In order to synthesize potassium peroxodicarbonate (K₂C₂O₆), a hydrogen peroxide solution (H₂O₂, 34.5 to 36.5%, Sigma Aldrich) and potassium hydroxide (KOH, 99.99%, Sigma Aldrich) were used. 8.5 mL of H₂O₂ was cooled with stirring at −20° C. Separately, 7 g of KOH was dissolved in 5.5 mL of deionized water, and this KOH solution was slowly added dropwise to the H₂O₂ solution at −20° C. When the mixed solution became transparent, the solution was stirred and CO₂ gas was strongly bubbled. When a light yellow product was precipitated, the powder was separated by filtration from the solution, and the separated powder was washed with cold ethyl alcohol (cooled to −10° C. before use, Samchun) and diethyl ether (cooled to −10° C. before use, Sigma Aldrich). The resulting powder was dried in a vacuum oven for 1 hour, and the dried powder was sealed in an Ar state before stored in an incubator at −10° C.

### EXAMPLE 1

### Manufacture of Lithium Air Battery

A freestanding CNT film was prepared by a filtration method. 0.12 g of CNT powder was dispersed in isopropyl alcohol for 20 minutes using a tip ultrasonicator. The dispersed CNTs were peeled off by filtration through glass fiber (5C, Adventec). All battery components were dried in a vacuum oven at 80° C. overnight prior to battery assembly. A Li—O₂/CO₂ battery was assembled using a metallic Li foil (diameter: 12 mm, thickness: 50 μm) as an anode, Celgard 2500 (diameter: 26 mm, thickness: 50 μm) or GF/C as a separator (diameter: 19 mm, thickness: 260 μm), a freestanding CNT film (diameter: 12 mm, thickness: 45 μm, mass: 1.2 mg) as a cathode, and a 0.5 M LiNO₃/DMAc electrolyte solution (150 μm) in an Ar-filled glove box (MOTek, O₂≤0.7 ppm, H₂O≈0 ppm). Contents of moisture of 0.5 M LiNO₃/DMAc were about 15 and 49 ppm, respectively (Karl Fischer titration, Metrohm). When a DMSO electrolyte solution was used, the GF/C separator was replaced with GB100R glass fiber for a battery test.

After the assembly, O₂ and CO₂ gasses (purities of both gases: 99.999%, Daesung Industrial Gases) were simultaneously introduced at flow rates of 90 and 10 sccm, respectively, for 15 minutes to provide 90/10 v/v %. For several OEMS tests, metallic Li was replaced with LiFePO₄ (LFP). LFP slurry was prepared by mixing LFP powder (carbon coating, Prayon), SuperP (Timcal), and polyvinylidene fluoride (PVdF, Arkema) in N-methyl-2-pyrrolidone (NMP, Sigma Aldrich, 99%) at a weight ratio of 8:1:1 using a mixer (THINKY Corporation, ARE-310). This slurry was cast on a titanium foil (Welcos, 99.5%) using a doctor blade method and then dried in a vacuum oven at 100° C. for 60 hours. The areal mass load, thickness, and diameter of the LFP electrode were 8 mg·cm⁻² or less, 790 μm, and 14 mm, respectively.

Electrochemical measurement was performed using a battery cycler (Versa Stat3 (AMETEK) or WPG100e (WonATech)). The battery was rest in an incubator for 2 hours, and then the battery was operated in an incubator maintained at −10° C. (IN6₀₄, Yamato). When the battery was operated at 25° C., the incubator was replaced with an incubator (INE800, Yamato). The first plateau proportion and the number of cycles of the battery were measured and shown in Table 1.

### EXAMPLE 2

A process was performed in the same manner as that of Example 1, except that the temperature was changed to 0° C.

### EXAMPLE 3

A process was performed in the same manner as that of Example 1, except that the temperature was changed to −5° C.

### EXAMPLE 4

A process was performed in the same manner as that of Example 1, except that the temperature was changed to −15° C.

### Comparative Example 1

A process was performed in the same manner as that of Example 1, except that the temperature was changed to 25° C.

### Comparative Example 2

A process was performed in the same manner as that of Example 1, except that 0.5 M LiTFSI/tetraglyme was used as an electrolyte solution.

### Comparative Example 3

A process was performed in the same manner as that of Example 1, except that 0.5 M LiTFSI/tetraglyme was used as an electrolyte solution and the temperature was changed to 0° C.

### Comparative Example 4

A process was performed in the same manner as that of Example 1, except that 0.5 M LiTFSI/tetraglyme was used as an electrolyte solution and the temperature was changed to 25° C.

TABLE 1

| | | | Number of |
|---|---|---|---|
| | | First | cycles |
| | | plateau | (based on 50 |
| | | proportion | mA/g, 500 |
| O₂:CO₂ = 90:10 | Classification | (%) | mAh/g) |
| Example 1 | −10° C., 0.5M | 30 | ~100 |
| | LiNO₃/DMAc | | |
| Comparative | 25° C., 0.5M | 2 | ~5 |
| Example 1 | LiNO₃/DMAc | | |
| Comparative | −10° C., 0.5M | 90 | 0 |
| Example 2 | LiTFSI/tetraglyme | | |
| Comparative | 0° C., 0.5M | 86 | ~2 |
| Example 3 | LiTFSI/tetraglyme | | |
| Comparative | 25° C., 0.5M | 47 | ~20 |
| Example 4 | LiTFSI/tetraglyme | | |

### EXAMPLE 5

A process was performed in the same manner as that of Example 1, except that the volume ratio of O₂ gas to CO₂ gas was changed to 70:30.

### EXAMPLE 6

A process was performed in the same manner as that of Example 5, except that the temperature was changed to 0° C.

### EXAMPLE 7

A process was performed in the same manner as that of Example 5, except that the temperature was changed to −5° C.

### EXAMPLE 8

A process was performed in the same manner as that of Example 5, except that the temperature was changed to −15° C.

### Comparative Example 5

A process was performed in the same manner as that of Example 5, except that the temperature was changed to 25° C.

### Comparative Example 6

A process was performed in the same manner as that of Example 5, except that 0.5 M LiTFSI/tetraglyme was used as an electrolyte solution.

### Comparative Example 7

A process was performed in the same manner as that of Example 5, except that 0.5 M LiTFSI/tetraglyme was used as an electrolyte solution and the temperature was changed to 0° C.

### Comparative Example 8

A process was performed in the same manner as that of Example 5, except that 0.5 M LiTFSI/tetraglyme was used as an electrolyte solution and the temperature was changed to 25° C.

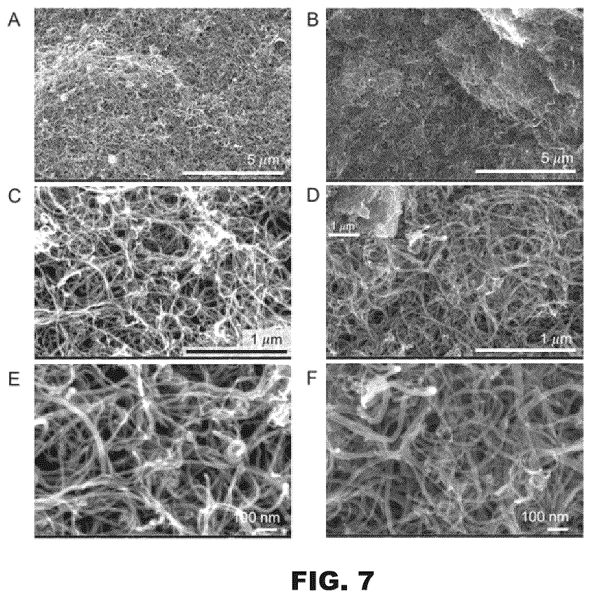

When tetraglyme was used as the electrolyte solution, although a relatively long first charge plateau was exhibited, the cyclability was poor. On the other hand, in the case where DMAc was used as the electrolyte solution, when O₂:CO₂ was 90:10, 100 cycles were performed at −10° C. These results indicate that the cyclability may be improved when peroxo-linked C₂O₆²⁻ is formed at a low temperature. In addition, it was found that Li₂CO₃ accumulation hardly occurred in the DMAc-based battery (FIGS. 7A to 7F), which appeared to have contributed to the excellent cyclability. This approach may be applied to a lithium air battery and may lead to new approaches to improve the cyclability that could not be achieved with only O₂ gas.

### Experimental Example 1

### Online Electrochemical Mass Spectrometry (OEMS) Analysis

A gas generation profile during a charge process was measured in a self-produced OEMS. The assembled Li—O₂/CO₂ battery described above was first discharged to 1,000 mAh·g_{c}⁻¹. Subsequently, the cell was purged with Ar gas (99.999%, Daesung Industrial Gases), and a headspace of the battery was changed from an Ar-filled glove box to an OEMS compatible storage (Tomcell). These batteries were connected to the OEMS, the charge process was performed at 1,000 mAh·g_{c}⁻¹, and a change in partial pressure of generated gas was observed. The generated gas was collected and analyzed every hour using a mass spectrometer (RGA200, Stanford Research Systems). A preloaded K₂C₂O₆ electrode was prepared by adding 0.0022 g of as-synthesized K₂C₂O₆ powder to a freestanding CNT electrode in an Ar-filled glove box. This electrode was charged at 10° C. with OEMS analysis.

### Experimental Example 2

### Ionic Conductivity of Electrolyte Solution

An ionic conductivity of the electrolyte solution was measured at a desired temperature using an ionic conductivity battery (Tera leader®). The cell was maintained with a fixed distance between two stainless steel electrodes of 0.2 cm, and the diameter and the area of the electrode was 14 mm and 1.539 cm², respectively. An assembled battery filled with an electrolyte solution was transferred to an incubator and stabilized at a desired temperature at least 2 hours before measurement. An electrochemical impedance spectroscopy (EIS) test was investigated using VersaStat3 at a DC voltage amplitude of 10 mV and a frequency window of 10⁵-1 Hz. The ionic conductivity of each electrolyte solution was estimated using the following equation.

$$σ = \frac{L}{R \times A}$$

Here, σ is an ionic conductivity, R is a solution resistance, A is an electrode area,

and L is a distance between two electrodes.

### Experimental Example 3

### Sample Analysis

For ex-situ analysis, the tested Li—O₂/CO₂ battery was purged with Ar gas and disassembled in an Ar-filled glove box. The CNT electrode was immersed in diglyme (99.5% anhydrous, Sigma Aldrich) for at least 10 minutes and rinsed three times with fresh diglyme. The diglyme solvent was dried using a 4 Å molecular sieve for longer than a day, and this process was repeated three times before use (H₂O<15 ppm). Thereafter, the CNT electrode was dried in a vacuum chamber at room temperature overnight. A GF/C glass fiber separator used for Raman analysis was collected immediately after the cell test without a washing process. X-ray diffraction (XRD, Rigaku Dmax 2000 diffractometer) analysis at KAIST Analysis Center for Research Advancement (KARA) was performed using Ni-filtered Cu-Kα radiation (λ=1.5418 Å). Fourier-transform infrared spectroscopy (FTIR, Nicolet i S50 spectrometer, Thermo Fisher Scientific) analysis was investigated using a portable glove box system purged with Ar gas. The sample was mixed with CsI powder (>99.99% purity, Kanto Chemical Co.), and pellets were prepared in an Ar-filled glove box. The Raman analysis was performed using a Raman spectrometer (Acton Spectra Pro 2300i) with He/Ne laser (633 nm), an integrated microscope (Olympus BX 43, objective×50, NA=0.55), and a thermoelectrically cooled 1,024×127 pixel charge-coupled device (CCD) detector (ANDOR, DV401A-BV). A holographic grid was 1,200 grooves mm⁻¹. KARA's scanning electron microscope (SEM, Magellan400, FEI company) was used to image the CNT electrode.

Confirmation of Discharge Product in Li—O₂/CO₂ Battery

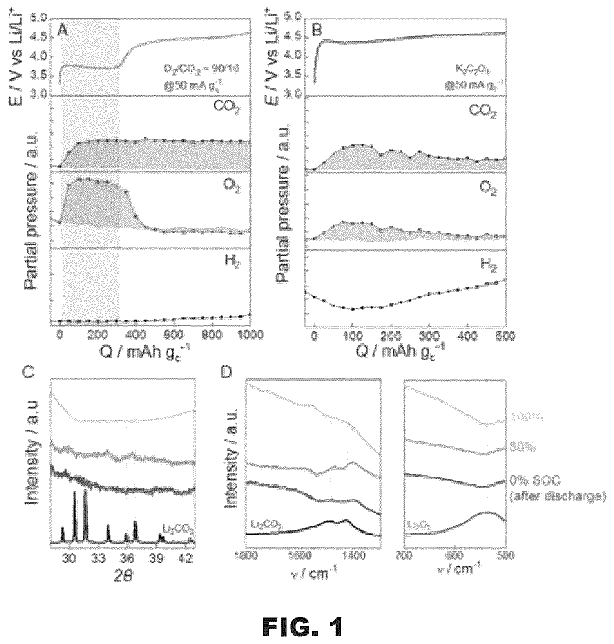

Chemical/electrochemical properties of the Li—O₂/CO₂ battery were verified by online electrochemical mass spectrometry (OEMS) and were compared with those of the Li—O₂ battery at 25° C. Metallic Li and a binder-free CNT film were used as an anode and a cathode, respectively. Gas in which a volume ratio of O₂:CO₂ was 90:10 and a 0.5 M LiTF SI/tetraglyme electrolyte solution were included in the fully sealed battery. After a discharge process at 25° C., two potential plateaus at 3.75 V and 4.45 V were observed at a current density of 50 mA·g_{c}⁻¹ and a capacity of 1,000 mAh·g_{c}⁻¹ , where g_{c} represents the mass of the CNT electrode (FIGS. 1A to 1D). In in situ gas analysis using OEMS, gases and a change in partial pressure occurring in each plateau were identified, allowing a discharge product to be inferred. In the first plateau at 3.75 V, O₂ and CO₂ were simultaneously generated in the Li—O₂/CO₂ battery (highlighted by the gray area), and in the subsequent plateau at 4.45 V, only CO₂ gas was generated. The continuous CO₂ generation during the entire charge process indicates that 10% CO₂ is sufficient to participate in all discharge reactions.

The fact that only O₂ is not generated in the Li—O₂/CO₂ battery indicates that Li₂O₂ may be ignored after discharge. X-ray diffraction (XRD) and Fourier-transform infrared (FTIR) spectra consistently confirmed a faint Li₂O₂ signal at the CNT electrode at the end of discharge (FIGS. 1C and 1D). However, the weak C—O stretching band of Li₂CO₃ was detected at 1,470 and 1,408 cm⁻¹, which indicated formation of amorphous Li₂CO₃ during discharging (FIG. 1D). Since CO₂ gas is electrochemically inert in a given potential range, first, a chemical route of forming Li₂CO₃ through a reaction of Li₂O₂ and CO₂ may be considered (Formula 1).

Li₂O₂(s)+CO₂(g)→Li₂CO₃(s)+0.5 O₂(g) (1)

After 50% state of charge (SOC) in the Li—O₂/CO₂ battery, XRD showed crystalline Li₂CO₃ with reflections of ⁻112, 020, and ⁻311 at 2θ at 33.9°, 35.8°, and 36.6°, respectively.

A C—O vibration band of Li₂CO₃ appeared in FTIR. This indicates the continuity of Li₂CO₃ deposition during the charge process. These Li₂CO₃-related signals were attenuated at 100% SOC during the first cycle. Therefore, in the OEMS analysis (FIG. 1A), it was confirmed that Li₂ CO₃ was decomposed at a high charge potential as CO₂ was generated exclusively in the second plateau of the Li—O₂/CO₂ battery.

The reaction of O₂ and CO₂ should be considered to identify the first charge-plateau reaction. CO₂ undergoes a chemical reaction with O₂^{⋅-} supplied through O₂ reduction (Formula 2). Soluble anionic materials such as peroxo-monocarbonate (CO₄^{⋅-} and peroxo-dicarbonate (C₂O₆²⁻) are produced before Li₂CO₃ is produced via an electrochemical (EC) route (Formulas 3 to 5).

O₂(g)+e⁻→O₂^{·-} (2)

O₂^{·-}+CO₂(g)→CO₄^{·-} (3)

CO₄^{·-}+O₂^{·-}+CO₂(g)→C₂O₆²⁻+O₂(g) (4)

C₂O₆²⁻+4 Li+ +2 O₂^{·-}→2 Li₂CO₃(s)+2 O₂(g) (5)

In the series of chemical reactions, C₂O₆²⁻ and Li₂CO₃ are assumed to be the main discharge products. In particular, since a reversible thermodynamic potential of C₂O₆²⁻ (3.27 V) is lower than that of Li₂CO₃ (3.82 V), C₂O₆²⁻ may be oxidized in the first charge plateau.

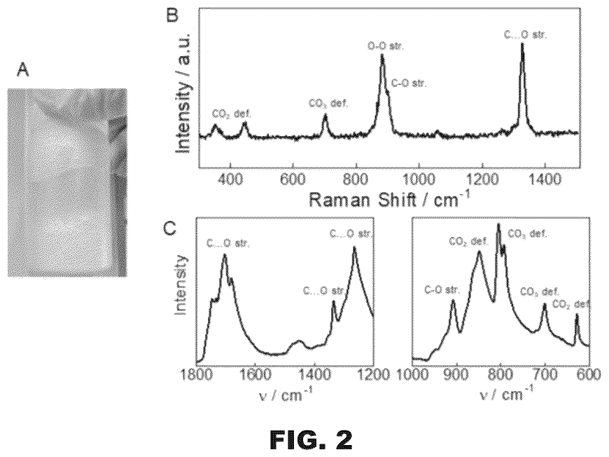

In order to confirm the presence of C₂O₆²⁻ in the Li—O₂/CO₂ battery, K₂C₂O₆ powder was synthesized and gas generation during electrochemical oxidation was analyzed. Light orange K₂C₂O₆ powder was prepared at −20° C. from a mixture of KOH, hydrogen peroxide (H₂O₂), and CO₂ gas. A peroxo-linked C₂O₆²⁻ structure in the K₂C₂O₆ powder was confirmed by Raman and FTIR spectra (FIGS. 2A to 2C). It should be noted that pure Li₂C₂O₆ powder is extremely difficult to synthesize at −20° C. due to its thermal instability. As-synthesized K₂C₂O₆ is also unstable and is converted into K₂CO₃ at about 8% per week at −20° C. Therefore, fresh K₂C₂O₆ powder was used in this experiment. In the OEMS analysis of K₂C₂O₆ powder preloaded on CNTs, both O₂ and CO₂ were generated (FIG. 1B). The charge potential of the K₂C₂O₆ powder (4.54 V) was higher than the first charge plateau of the Li—O₂/CO₂ battery. Thereafter, the generation of H₂ may be caused by impurities in the synthesized K₂C₂O₆. Therefore, it was confirmed that C₂O₆²⁻ was one of the main discharge products in the Li—O₂/CO₂ battery. However, C₂O₆²⁻, which has low thermal stability, is converted into Li₂CO₃ during the charge process and affects the second charge plateau at 25° C. (see Formula 5).

Temperature Influence on C₂O₆²⁻ Stability

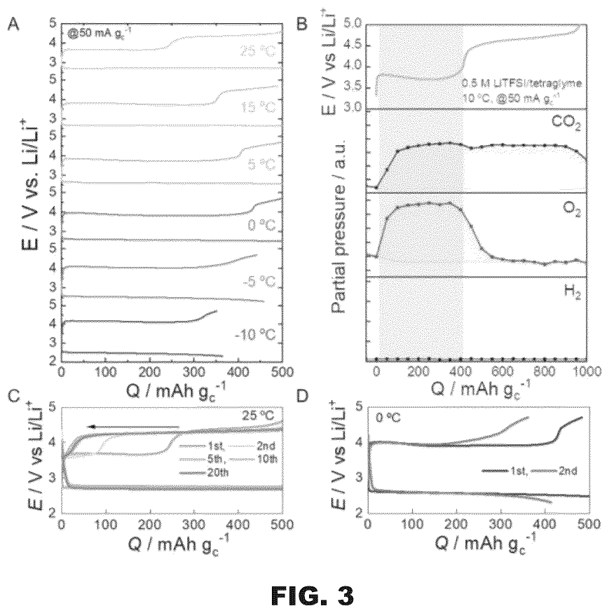

Inhibiting the conversion of C₂O₆²⁻ into Li₂CO₃ is a key point of reducing the charge potential and improving the cyclability of the Li—O₂/CO₂ battery. A high charge potential is required for Li₂CO₃ to oxidize, which unfortunately decomposes both the CNT electrode and the electrolyte solution. In addition, Li₂CO₃ is partially decomposed even at 4.5 V, and insulating Li₂CO₃ is accumulated on the CNT electrode. Therefore, a constant current test was performed at a temperature of lower than 25° C. to preserve C₂O₆²⁻ species in the Li—O₂/CO₂ battery. When the temperature was lowered from 25° C. to −10° C., the first charge plateau became longer while the second charge plateau became shorter (FIG. 3A).

The proportion of the first plateau was estimated to be 47% or less at 25° C. and reached 86% or less at 0° C. during the charge process. It was shown that O₂ and CO₂ were simultaneously generated in the first charging plateau, which was extended at 10° C., and the stability of C₂O₆²⁻ at a low temperature was confirmed (FIG. 3B). However, voltage polarization was expanded even at a low temperature. The discharge potential decreased from 2.72 V at 25° C. to 2.57 V at 0° C., while the first/second charge plateaus increased from 3.68/4.4 V to 3.84/4.53 V, respectively. As a result, the capacity thereof was limited at cut-off potentials of 2.3 V and 4.7 V for discharge and charge, respectively, and less than 500 mAh·g_{c}⁻¹ was provided at 0 and −10° C. despite the extended first charge plateau.

Such a poor electrochemical reaction is due to the high viscosity of the tetraglyme solvent. The conductivity of 0.5 M LiTF SI/tetraglyme was 2.175 (±0.015) mS·cm⁻¹ at 25° C. and decreased to 0.73 (±0.01) mS·cm⁻¹ at −10° C. (see Table 2).

TABLE 2

| | Electrolyte solution | | | |
|---|---|---|---|---|
| | 0.5M LiTFSI/tetraglyme | | 0.5M LiNO₃/DMAc | |
| | Temperature | | | |
| | −10° C. | 25° C. | −10° C. | 25° C. |
| Conductivity | 0.72 | 2.16 | 5.87 | 8.96 |
| (first, mS · cm⁻¹) | | | | |
| Conductivity | 0.74 | 2.19 | 5.60 | 8.43 |
| (second, mS · cm⁻¹) | | | | |

In the Li—O₂/CO₂ battery, the actual ionic conductivity of the electrolyte solution should be lower than the measured value because C₂O₆²⁻ is dissolved in the solution. In terms of cyclability, at 25° C., the Li—O₂/CO₂ battery was able to perform 30 cycles at 50 mA·g_{c}⁻¹ and 500 mAh·g_{c}⁻¹ (FIG. 3C). During the charge process, the proportion of the first charge plateaus was 47% for the first cycle and decreased to 17% for the second cycle. As a result, the plateau associated with C₂O₆²⁻ disappeared in the fifth cycle, meaning that Li₂CO₃ dominated the chemical reaction of the battery. In the test performed at 0° C., the discharge capacity also decreased in the second cycle due to the low ionic conductivity of the electrolyte solution (FIG. 3D). Moreover, the charge plateau associated with C₂O₆²⁻ decreased in the second cycle, suggesting increased Li₂CO₃ deposition.

Influence of Electrolyte Solution on C₂O₆²⁻ Stability

In order to balance the C₂O₆²⁻ stability and the ionic conductivity of the electrolyte solution, other solvents such as dimethoxyethane (DME), dimethylacetamide (DMAc), and dimethyl sulfoxide (DMSO) were considered. A charge profile was confirmed at 25° C. in a Li—O₂/CO₂ battery using a LiFePO₄ (LFP) electrode instead of metallic Li. In all the batteries, similar discharge potentials of 2.7 to 2.9 V compared to Li/Li⁺ were shown in a constant current profile, but the proportions of the first charge plateau to the total capacity were different. DME (and tetraglyme) showed 40 to 50% of the first plateau during the charge process, whereas DMAc and DMSO showed 4% or less and less than 1%, respectively. These results indicate that solvent properties also affect the stability of C₂O₆²⁻. This trend is related to the dielectric constant (c) and Gutmann donor number (DN) of the solvent (see Table 3).

TABLE 3

| | Tetraglyme | DME | DMAc | DMSO |
|---|---|---|---|---|
| Dielectric | 7.8 | 7.2 | 37.8 | 46.5 |
| constant (ε) | | | | |
| Donor number (DN) | 16.6 | 20.8 | 27.8 | 29.8 |

In the case of DMAc, the first charge plateau was short at 25° C., but the viscosity and the melting point were low, and thus a charge/discharge cycle was performed at a low temperature. The ionic conductivity of 0.5 M LiNO₃/DMAc was 8.695 (±0.265) mS·cm⁻¹ at 25° C. and 5.735 (±0.135) mS·cm⁻¹ at −10° C., which was higher than that of the tetraglyme electrolyte solution (see Table 2). Therefore, a 0.5 M LiNO₃ salt was used in DMAc to stabilize the Li electrode surface against DMAc.

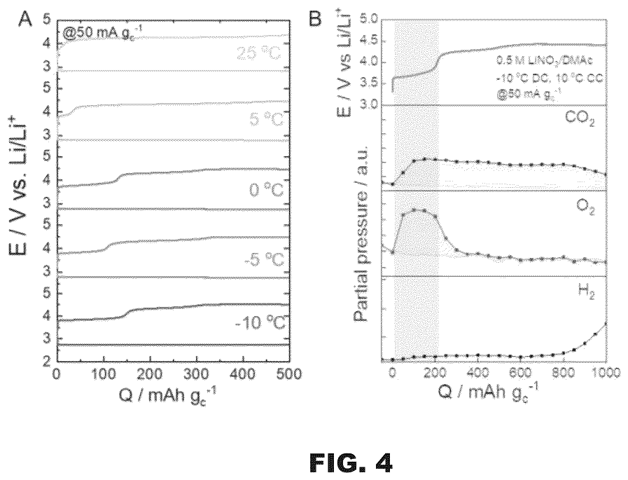

The Li—O₂/CO₂ battery including 0.5 M LiNO₃/DMAc showed temperature-dependent charge behavior (FIG. 4A). The first charge plateau was extended as the temperature decreased, resulting in a proportion of 30% (150 mAh·g_{c}⁻¹ or less) during the charge process at −10° C. In addition, in the case of the battery including DMAc, the voltage polarization was not significantly changed. Compared to the polarization of 1.68 V using 0.5 M LiTFSI/tetraglyme at −10° C., the polarization of the 0.5 M LiNO₃/DMAc battery was only 1.09 V at a current density of 50 mA·gc⁻¹, which was due to the higher ionic conductivity. A difference in voltage polarization between 0° C. and −10° C. was only 0.09 V for LiNO₃/DMAc compared to 0.33 V for LiTFSI/tetraglyme. As a result of OEMS, CO₂ and O₂ generations were consistent in the first plateau after discharge at 25° C. and −10° C. (FIG. 4B). The O₂ pressure increased more rapidly than the CO₂ pressure during the initial charge process (0 to 50 mAh·g_{c}⁻¹, FIG. 4B), which was different from the gradual generation of O₂ and CO₂ gases in the K₂C₂O₆ powder (FIG. 1B). In the Li—O₂/CO₂ battery, CO₄^{·-} appears to be stabilized and oxidized during the initial charge process together with C₂O₆²⁻. After the charge process is finished, DMAc begins to decompose and H₂ gas is generated.

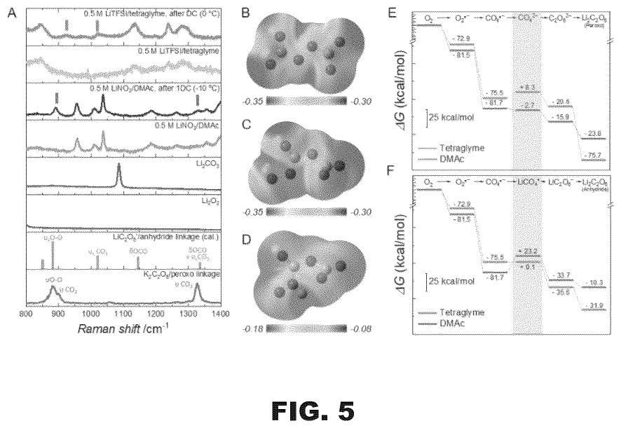

Despite the similar temperature-related charge behavior, in the case of the tetraglyme solvent, a longer first plateau capacity than DMAc was provided at the same temperature (FIGS. 3A and 4A). As such, the reason C₂O₆²⁻ shows different stability appears to be due to the molecular structure under given conditions. To confirm this hypothesis, the GF/C separator used in the Li—O₂/CO₂ battery was collected immediately after the first discharge and analyzed by Raman spectroscopy. The separator used with 0.5 M LiTFSI/tetraglyme for discharge at 0° C. showed prominent vibration bands at 919 cm⁻¹ and 1,019 cm⁻¹ (FIG. 5A). In a previous study, a similar Raman vibration at 920 cm⁻¹ was detected in anhydride-linked C₂O₆²⁻. In DFT calculation, these vibration bands were assigned as the O—O stretching band (881 cm⁻¹) and CO₃ symmetric stretching band (1,020 cm⁻¹) of anhydride-linked C₂O₆²⁻ pared with Lit, respectively (FIG. 5A). Although the former case has a lower Raman shift than the experimental results, all these features suggest that anhydride-linked C₂O₆²⁻ is the main soluble product of 0.5 M LiTFSI/tetraglyme. In comparison, the separator with 0.5 M LiNO₃/DMAc at −10° C. had an O—O stretching band at 891 cm⁻¹ and a small C—O stretching band at 1,328 cm⁻¹ (FIG. 5A). The other phases and counter cations have a slight shift (3 to 9 cm^{31 1}) in the O—O band vibration, but match well with those of the K₂C₂O₆ powder, indicating peroxo-linked C₂O₆²⁻. In addition, neither Li₂CO₃ nor Li₂O₂ was present in all the separator samples (FIG. 5A).

The electrochemical process that depends on the electrolyte solution is related to the dielectric constant (c) and the Gutmann donor number (DN) of the electrolyte solution. DMAc having a high dielectric constant (c) and Gutmann donor number (DN) further solvates Li⁺. Therefore, free O₂^{·-} reacts with CO₄^{·-} (Formula 6), and the subsequent reaction of CO₄²⁻ with CO₂ forms peroxo-linked C₂O₆²⁻ (CO₂OOCO₂²⁻, Formula 7 and FIG. 5B). This chemical process may be supported by the DFT calculation showing the decline step of Formula 6 (FIG. 5E for −10° C.).

CO₄^{·-}+O₂^{·-}→CO₄²⁻+O₂ (6)

CO₄²⁻+CO₂→C₂O₆²⁻ (peroxo-linked) (7)

In comparison, tetraglyme having a low dielectric constant (c) is not preferable for forming highly charged CO₄²⁻ and C₂O₆²⁻ (FIG. 5C). A more speculative route is formation of a Li^{+ . . . CO}₄^{·-} ion pair (Formula 8), and anhydride-linked LiC₂O₆⁻ (LiCO₂CO₂OO⁻, Formula 9 and FIG. 5D) is produced as O₂^{·-} reacts with CO₂. The DFT calculation predicts a similar chemical route at −10° C. (FIG. 5F).

CO₄^{·-}+Li⁺→LiCO₄^{·} (8)

LiCO₄^{·}+O₂^{·-}+CO₂→LiC₂O₆⁻ (anhydride-linked)+O₂ (9)

Since an extended first charge plateau appears when tetraglyme is used, a stable anhydride-linked LiC₂O₆⁻ may be inferred in the Li—O₂/CO₂ battery. However, the DFT calculation shows more excellent stability for peroxo-linked C₂O₆²⁻ than for anhydride-linked LiC₂O₆⁻− for Li₂CO₃. ΔG for peroxo-linked C₂O₆²⁻ and anhydride-linked LiC₂O₆⁻ to become Li₂CO₃ were measured to be −32 and −42.6 kcal/mol, respectively. Although the exact reason is not yet known, it is presumed that LiC₂O₆⁻ in the anhydride form is slowly converted into Li₂CO₃ through structural rearrangement, in contrast to C₂O₆²⁻ in the peroxo form, which undergoes simple O—O link cleavage.

Improved Cyclability of Li—O₂/CO₂ Battery Including 0.5 M LiNO₃/DMAc at −10° C.

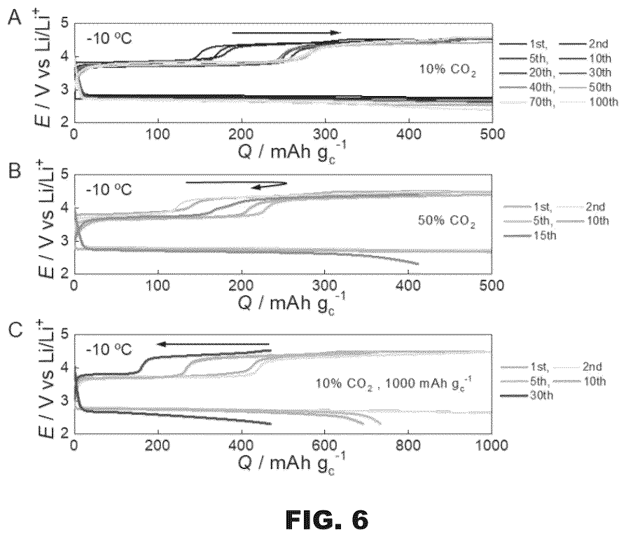

At 50 mA·g_{c}⁻¹ and 500 mAh·g_{c}⁻¹, the Li—O₂/CO₂ battery including 0.5 M LiNO₃/DMAc was stably operated for 100 cycles at −10° C. (FIG. 6A), which was superior to 0.5 M LiTFSI/tetraglyme system. The proportion of the first charge plateaus decreased from 35% to 33% during the first five cycles. However, this plateau was extended to 50% by the 50th cycle and to 55% by the 100^{th} cycle. C₂O₆²⁻ electrochemistry was reversible and C₂O₆²⁻ became the main discharge product during a long-term cycle. Due to the high ionic conductivity of the DMAc solution, a constant voltage polarization appeared. In addition, in the case of the CNT electrode decomposed in the Li—O₂/CO₂ battery, a negligible solid product was observed in a scanning electron microscope (SEM) image after 70 cycles (FIGS. 7A to 7F), and it was confirmed that almost no Li₂CO₃ was accumulated. The reversible process of Li₂CO₃ formation and decomposition is a key point of improving the cyclability along with C₂O₆²⁻ stability.

In an additional cycle test under harsh conditions, an important factor determining Li₂CO₃ decomposition has been identified. When the O₂/CO₂ ratio was set to a volume ratio of 50:50, the capacity began to decrease after the 10^{th} cycle at −10° C. (FIG. 6B), reflecting Li₂CO₃ accumulation. However, the charge curve was similar to the above curve at a volume ratio of O₂/CO₂ of 90:10 (FIG. 6A), and the capacity of the first charge plateau and the proportion of plateaus up to the 10^{th} cycle were similar. Therefore, both systems underwent the same electrochemical process and produced similar amounts of C₂O₆²⁻. A rapid capacity reduction is presumed to occur due to the excess of Li₂CO₃ during cycling through the forced forward reaction in Formulas 4 and 5 under a high CO₂ partial pressure. In addition, when the capacity increased to 1,000 mAh·g_{c}⁻¹ in the Li—O₂/CO₂ (volume ratio of 90:10) battery at −10° C., the cyclability was deteriorated (FIG. 6C). The specified charge method for the electrochemical process is the same, resulting in a capacity of more than twice that of the first charge plateau at a total capacity of two times. However, due to the double discharge capacity, the Li₂CO₃ deposition became thicker, and the decomposition during the charge process was slowed down, and as a result, a reduction in capacity occurred from the 5^{th cycle.}

As set forth above, the lithium air battery according to the present disclosure reduces a discharge product such as Li₂CO₃, which deteriorates the performance of the lithium air battery, and exhibits excellent cyclability at a low temperature. Specifically, in the lithium air battery according to the present disclosure, a solvent having a high ionic conductivity at a low temperature is used as the electrolyte solution of the battery, such that the first charge plateau proportion increases, thereby improving the cyclability.

Further, in the lithium air battery according to the present disclosure, almost no solid product deposited on the electrode of the battery is generated after the cycle is performed, and Li₂CO₃ is completely decomposed during the second plateau charge process, such that significantly excellent cyclability is exhibited.

Further, as the lithium air battery according to the present disclosure is operated at a low temperature, C₂O₆²⁻, which is an intermediate derived from CO₂, may be significantly stabilized, the first charge plateau in which O₂ and CO₂ gases are generated simultaneously may be extended, and significantly excellent cyclability may be realized.

Although the exemplary embodiments of the present disclosure have been described hereinabove, various modifications and equivalents of the present disclosure are possible, and the exemplary embodiments may be appropriately modified and similarly applied. Therefore, contents described do not limit the scope of the present disclosure as defined by the claims.

What is claimed is:

1. A lithium air battery comprising:
an anode including lithium;
a cathode located so as to face the anode and using oxygen as a cathode active material;
an electrolyte solution located between the anode and the cathode and containing a solvent and a lithium salt; and
carbon dioxide,
wherein the solvent is a heteroaliphatic solvent having a dielectric constant of 30 or more and containing a nitrogen atom or a sulfur atom.

2. The lithium air battery of claim 1, wherein the solvent has 2 to 8 carbon atoms.

3. The lithium air battery of claim 1, wherein the solvent is at least one selected from the group consisting of dimethylacetamide (DMAc), dimethyl sulfoxide (DMSO), dimethylformamide (DMF), acetonitrile, and nitromethane.

4. The lithium air battery of claim 1, wherein the solvent is an amide-based compound.

5. The lithium air battery of claim 1, wherein the lithium air battery is operated at a temperature that is equal to or higher than a melting point of the solvent and is 5° C. or lower.

6. The lithium air battery of claim 5, wherein the lithium air battery is operated at −20 to 0° C.

7. The lithium air battery of claim 1, wherein the carbon dioxide is supplied to one side of the cathode as a mixed gas mixed with oxygen.

8. The lithium air battery of claim 7, wherein a volume ratio of the oxygen to the carbon dioxide in the mixed gas is 5:5 to 9:1.

9. The lithium air battery of claim 1, wherein the carbon dioxide is dissolved in the electrolyte solution.

10. The lithium air battery of claim 1, wherein a Gutmann donor number (DN) of the solvent is 25 to 30.

11. The lithium air battery of claim 1, further comprising a separator located between the cathode and the anode.

12. The lithium air battery of claim 1, wherein the cathode includes a carbon body.

13. The lithium air battery of claim 1, wherein the lithium salt includes at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄FiONO₄S₂ (LiBETI), LiPF₆, LiBF₄ , LiSbF₆, LiAsF₆, LiC₄F₉SO₃, LiClO₄, LiAlO₂, LiAlCl₄, LiCl, LiI, LiBr, and LiB(C₂O₄)₂.

14. The lithium air battery of claim 13, wherein the lithium salt includes LiNO₃.

15. An electrolyte composition for a lithium air battery, comprising:
a lithium salt;
a heteroaliphatic solvent having a dielectric constant of 30 or more and containing a nitrogen atom or a sulfur atom; and
dissolved carbon dioxide.

16. The electrolyte composition of claim 15, wherein the solvent has 2 to 8 carbon atoms.

17. The electrolyte composition of claim 15, wherein the solvent is at least one selected from the group consisting of dimethylacetamide (DMAc), dimethyl sulfoxide (DMSO), dimethylformamide (DMF), acetonitrile, and nitromethane.

18. The electrolyte composition of claim 15, wherein the solvent is an amide-based compound.

19. The electrolyte composition of claim 15, wherein the solvent is dimethylacetamide (DMAc).

20. The electrolyte composition of claim 15, wherein the lithium salt includes at least one selected from the group consisting of LiNO₃, LiNO₂, LiC₂F₆NO₄S₂ (LiTFSI), LiCF₃SO₃ (LiOTf), LiF₂NO₄S₂ (LiFSI), LiC₄F₁₀NO₄S₂ (LiBETI), LiPF₆, LiBF₄, LiSbF₆, LiAsF₆, LiC₄F₉SO₃, LiClO₄, LiAlO₂, LiAlCl₄, LiCl, LiI, LiBr, and LiB(C₂O₄)₂.
